(19) United States
(12) Patent Application Publication
(10) Pub. No.: US 2017/0121983 A1
(43) Pub. Date: May 4, 2017

(54) PANEL ASSEMBLY, AND EMBOSSING ELEMENT AND DECORATIVE PAPER SHEET FOR PRODUCING SUCH A PANEL ASSEMBLY

(71) Applicant: Kaindl Flooring GmbH, Wals (AT)

(72) Inventor: Gerhard Dürnberger, Strasswalchen (AT)

(21) Appl. No.: 15/319,420

(22) PCT Filed: Jun. 15, 2015
(86) PCT No.: PCT/EP2015/063318

§ 371 Date: Dec. 16, 2016

(30) Foreign Application Priority Data
Jun. 18, 2014 (DE) 10 2014 211 769.0

(51) Int. Cl. E04F 15/00; B44C 5/04; B44C 1/24; E04F 13/00

(52) U.S. Cl. CPC E04F 15/00; E04F 13/00; B44C 5/0469; B44C 1/24

(57) ABSTRACT

A panel assembly (34) has a plurality of panels (30), of which each includes a base element (10) which has a decorative paper (12) on the surface thereof facing away from the substrate, which decorative paper reproduces the appearance of a natural material, wherein each panel (30) is provided, using an embossing element, with a surface structure substantially synchronous to the decoration (16) of the visible face of the decorative paper (12), and the decoration (16) of a first number of panels (30-1) is subdivided by means of an imitation joint (32) extending in the longitudinal direction (L) of the respective panel (30-1) into a first decorative portion (16a) of a first predetermined width and into a second decorative portion (16b) of a second predetermined width, whereas the decoration (16) of the remaining panels (30-2) is free of such subdivisions in the width direction (B). An embossing element and a decorative paper sheet for producing such a panel assembly can also be provided.

### BACKGROUND

In a very general manner, the invention relates to the field of panels which are used to cover a substrate, for example a floor, a wall, a ceiling and the like, the panels each comprising a base element which is covered with a decorative paper on a surface facing away from the substrate, the decorative paper being printed with a decoration on the visible surface thereof, which decoration has the appearance of a natural material, and each panel being provided with a textured region which extends in a substantially synchronous manner with the decoration.

### BRIEF DESCRIPTION

At this juncture, it is noted that, in addition to wood and stone, ceramics, for example tiles, are also considered to be natural materials in this technical field, both in the prior art and in connection with the present invention.

Panels of this type are usually produced from a base plate which is later divided into a plurality of panels by cutting, for example by sawing. The base plate can for example be made of MDF (medium density fiberboard), HDF (high density fiberboard), OSB (oriented strand board) or any other suitable material. A decorative paper sheet is applied to the base plate, for example glued to the base plate by means of artificial resin. In order to protect the decorative paper sheet from damage, resulting from wear or from the effect of sunlight for example, a transparent protective layer which covers the decorative paper sheet may also be provided. This protective layer may also be formed by an artificial resin layer, into which material particles, for example corundum particles, which increase wear resistance, and/or what is referred to as “overlay paper” can be embedded. A textured region which extends in a substantially synchronous manner with the decoration of the decorative paper sheet is inserted into the protective layer, for example by means of an embossing element, preferably an embossing plate.

All of these steps are carried out before the base plate is cut into the plurality of panels.

This approach gives rise to the problem of what is referred to as “paper growth”, i.e. the measurements of the decorative paper changing as a result of said decorative paper being impregnated with artificial resin. By selecting a suitable material and a suitable method, attempts are made to control paper growth such that, in the finished product, the decoration and the textured region are arranged synchronously with one another as perfectly as possible, i.e. with the highest possible degree of congruency in a direction which extends orthogonally to the panel surface. In practice, however, it is not possible to avoid misalignments, i.e. the decorative elements and the respective textured elements being offset relative to one another, in the range of ±0.2%. If the decoration and the textured region match one another to an extent which falls within these tolerance limits, they are considered to be “substantially synchronous” within the meaning of the present invention.

If the base plate is 2050 mm wide, which corresponds to ten panels having a width of approximately 200 mm once the waste from sawing has been taken into account, the decoration and the textured region may be misaligned by up to ±4.1 mm between the left edge and the right edge of the base plate. This can be tolerated in decorations which only resemble a natural product, for example wood, stone or ceramic surfaces, because these products typically have an irregular appearance, and therefore the eye does not notice the misalignment. However, there are also panels of which the decoration contains simulated joints so as to increase the variability of the installation pattern (see for example DE 10 2005 047 767 A1). Owing to the substantially straight course of these simulated joints, the eye notices the misalignment particularly if the paper growth direction extends orthogonally to the extension direction of the simulated joint, i.e. in simulated joints that extend substantially in parallel with the longitudinal sides of the panels. In particular, the decorative element displaying the simulated joint and the textured arrangement displaying the simulated joint may not overlap one another in the width direction of the panel, but may instead be arranged next to one another in a manner such that they are completely separate from one another.

The object of the present invention is that of remedying this problem.

The concept behind achieving this object, which is common to all of the aspects of the invention explained in the following, is both that of not providing all of the panels which have been produced from a base plate with a simulated joint, and that of arranging the panels that are provided with a simulated joint so as to be symmetrical with respect to the center of the width extension of the base plate to the best possible extent, i.e. with a deviation of at most one panel.

In this case, the “width extension” is understood to mean the extension which extends in the direction of the width of the panels manufactured from the base plate. Furthermore, the wording “symmetrical with a deviation of at most one panel” is understood to mean the following: if the base plate comprises an even number of panels in its width extension and if an even number of panels are provided with a simulated joint or if the base plate comprises an uneven number of panels in its width extension and if an uneven number of panels are provided with a simulated joint, the panels that are provided with a simulated joint are arranged symmetrically with respect to the center of the width extension of the base plate. If, however, the base plate comprises an even number of panels in its width extension and if an uneven number of panels are provided with a simulated joint or if the base plate comprises an uneven number of panels in its width extension and if an even number of panels are provided with a simulated joint, more panels that are provided with a simulated joint are arranged on one side of the center of the width extension of the base plate than on the other side of the width center.

Given that the degree of offset between the decoration and the textured region resulting from paper growth increases from the center of the width extension of the base plate to the two sides of the base plate, the arrangement, which is as symmetrical as possible with respect to the center of the width extension of the base plate, of the panels that are provided with a simulated joint means that, even in the case of the panels that are provided with a simulated joint and are furthest away from the center of the width extension of the base plate, the decorative element displaying the simulated joint and the portion of the textured region displaying the simulated joint are offset from one another to a lesser extent than when the entire surface of the base plate is covered with panels that are provided with a simulated joint. As a result, the decorative element displaying the simulated joint and the portion of the textured region displaying the simulated joint are prevented from coming apart and separation of this kind can be completely avoided if the decorative element displaying the simulated joint and the portion of the textured region displaying the simulated joint have suitable measurements and when there is a suitable number of panels provided with a simulated joint in relation to the total number of panels.

According to a first aspect of the present invention, the inventive concept is achieved by a panel unit which comprises a plurality of rectangular panels intended for covering a substrate, i.e. by a sales unit comprising a plurality of panels of this type, all of the panels having the same panel width, each of the panels comprising a base element which comprises a decorative paper on the surface thereof which faces away from the substrate, which decorative paper is printed with a decoration on the visible surface thereof, which decoration has the appearance of a natural material, and, using an embossing element, each panel being provided with a textured region which extends in a substantially synchronous manner with the decoration on the visible surface of the decorative paper, and the decoration of a first number of panels being divided into a first decorative portion having a first predetermined width and a second decorative portion having a second predetermined width by means of a simulated joint which extends in the longitudinal direction of the particular panel, whereas the decoration of the remainder of the panels is not divided up in the width direction in such a manner.

In a development of the first aspect of the invention, it is proposed that the number of panels divided into the first decorative portion and the second decorative portion by means of the simulated joint is equal to the number of panels that are not divided up in such a manner. Therefore, the person creating the covering does not need to make sure that the correct number of panel units comprising panels that comprise simulated longitudinal joints and panel units comprising panels that do not comprise simulated longitudinal joints are provided in order to create a substrate having alternating rows of panels that comprise simulated longitudinal joints and rows of panels that do not comprise simulated longitudinal joints. Instead, according to this development of the invention, purchasing a particular number of panel units ensures that there is always the number of panels that comprise simulated longitudinal joints and the number of panels that do not comprise simulated longitudinal joints required for the alternating arrangement in question. Furthermore, the person installing the panels does not have to take the panels from different panel units, but can take them from one panel unit at a time.

At this juncture, it is noted that, using the panel unit according to the invention, it is not only possible to produce a substrate having alternating rows of panels that comprise simulated longitudinal joints and rows of panels that do not comprise simulated longitudinal joints as set out above, but it is also possible to lay the panels that comprise the simulated longitudinal joints and the panels that do not comprise the simulated longitudinal joints in a random manner, i.e. not following a specified order, which likewise produces an attractive appearance.

Furthermore, the width of the first decorative portion is different from the width of the second decorative portion. This can further increase the variability of the installation pattern of the covering of the substrate because, according to this development, there are three different plank widths. The widest plank width is provided by the panels which do not comprise a simulated joint, whereas the panels comprising a simulated joint provide two smaller plank widths that are different from one another.

In order to ensure in an even more reliable manner that the portion of the textured region displaying the simulated joint and the decorative element displaying the simulated joint at least overlap one another, the portion of the textured region displaying the simulated joint preferably covering all of the decorative element displaying the simulated joint, it is proposed that the ratio between the width of the decorative element displaying the simulated joint and the width of the portion of the textured region displaying the simulated joint is between approximately 1.5 and approximately 3.0, preferably between approximately 1.7 and approximately 2.3.

In order to make the simulated joint more noticeable, the portion of the textured region displaying the simulated joint may also have a degree of gloss that is different from the rest of the textured region. As a result, the portion of the textured region displaying the simulated joint reflects light in a different manner to the rest of the surface of the panel even at grazing incidence.

Covering panels are typically provided with a chamfer on at least one of the outer edges thereof, the chamfers of two adjacent panels, which chamfers adjoin one another in the installed state, form a joint, which is for example V-shaped. In order to make the appearance of the installed substrate look more realistic, it is proposed that the ratio between the width of the portion of the textured region of the panels comprising a simulated joint that displays the simulated joint and the width of the chamfer is between approximately 1.8 and approximately 2.2, preferably approximately 2.0.

In order to further increase the variability of the appearance, it is proposed that the first decorative portion and/or the second decorative portion of at least one of the panels comprising a simulated longitudinal joint is/are divided into at least a first decorative sub-portion and a second decorative sub-portion by means of at least one simulated joint that extends in the width direction of the particular panel. In this manner, it is possible for planks of various lengths to be displayed. If the decorations of the panels are designed such that said decorations transition into one another at outer edges that are not provided with a chamfer, in particular at their longitudinal ends that are not provided with a chamfer, even planks of which the lengths exceed those of the panels can be displayed.

It should be noted that it is of course also possible for panels that do not comprise any simulated longitudinal joints to be divided up by means of at least one simulated width joint, it being possible for these panels to also be designed having decorations that transition into one another at the longitudinal ends thereof.

According to a second aspect of the present invention, the inventive concept is achieved by an embossing element for forming a textured region in a plate provided with a decoration, the embossing element comprising a plurality of rectangular embossing regions which are arranged next to one another in the direction of the short sides of the rectangle, a first number of embossing regions being divided into a first embossing portion having a first predetermined width and a second embossing portion having a second predetermined width by means of an embossing arrangement which extends in parallel with the long sides of the rectangle, whereas the remainder of the embossing regions do not have any embossing arrangements of this kind that extend in parallel with the long sides of the rectangle, and the divided embossing regions being arranged on the embossing element so as to be directly adjacent to one another and symmetrical with respect to the width center of the embossing element, with a deviation of at most one embossing region.

According to a third aspect of the present invention, the inventive concept is achieved by a decorative paper which is printed with a decoration on the visible surface thereof, which decoration has the appearance of a natural material, the decorative paper comprising a plurality of rectangular decorative regions which are arranged next to one another in the direction of the short sides of the rectangle, a first number of decorative regions being divided into a first decorative portion having a first predetermined width and a second decorative portion having a second predetermined width by means of a decorative element which extends in parallel with the long sides of the rectangle, whereas the remainder of the decorative regions do not have any decorative elements of this kind that extend in parallel with the long sides of the rectangle, and the divided decorative regions being arranged on the decorative paper so as to be directly adjacent to one another and symmetrical with respect to the width center of the decorative paper, with a deviation of at most one decorative region.

With regard to the development possibilities of the embossing element according to the second aspect of the invention and of the decorative paper according to the third aspect of the invention, so as to avoid repetition, reference is made to the above discussion of the general concept on which the invention is based and of the panel unit according to the first aspect of the invention.

### BRIEF DESCRIPTION OF THE DRAWINGS

The invention will be described in more detail in the following with reference to the accompanying drawings of an embodiment.

FIG. 1 is a schematic plan view of a base plate which is covered with a decorative paper sheet and provided with a textured region, showing the base plate in the manner in which it can be used to produce the panel unit according to the invention;

FIG. 2 is a sectional view of a detail from FIG. 1 along the line II-II in FIG. 1;

FIG. 3 is a perspective view from below of an embossing plate;

FIGS. 4a to 4d are views intended to explain the expression “symmetrical with a deviation of at most one panel”; and

FIGS. 5 and 6 show two possible installation patterns which can be produced using the panel unit according to the invention.

### DETAILED DESCRIPTION

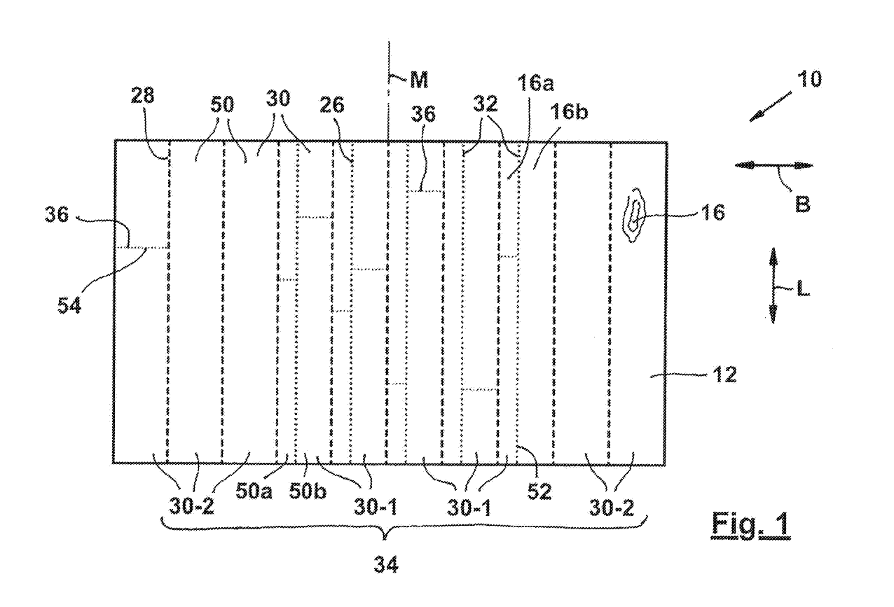

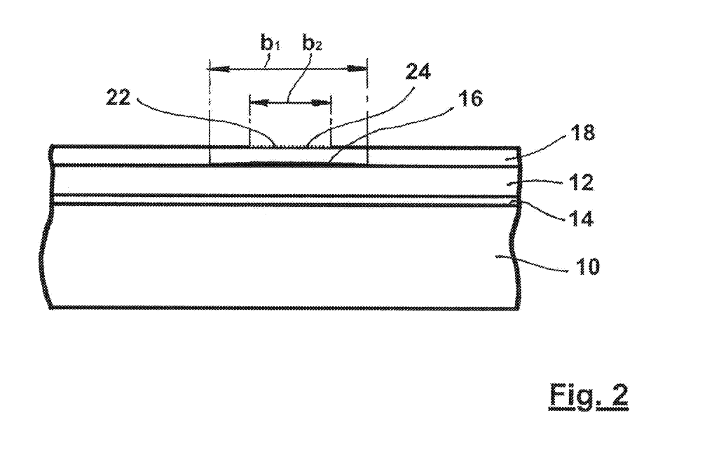

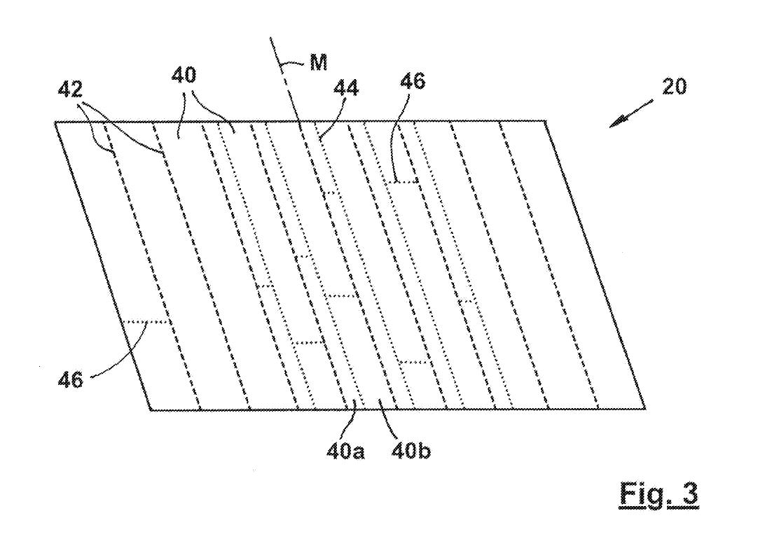

In FIG. 1, a base plate according to the invention is denoted in a general manner by 10. As can be seen in detail in FIG. 2, a decorative paper sheet 12 is applied to the base plate 10, which decorative paper sheet is impregnated with artificial resin and glued to the base plate 10 by means of an artificial resin layer 14. The decorative paper sheet 12 is printed with a decoration 16 which is shown only in part in FIGS. 1 and 2 (and only in a highly schematic manner) and has the appearance of a natural material, for example the appearance of wood, stone or ceramic. The decorative paper sheet 12 is also covered with a transparent protective layer 18, the function of which is to protect the decoration 16 from damage, resulting from wear or from the effect of sunlight for example. The protective layer 18 can also be formed by an artificial resin layer, into which material particles, for example corundum particles, which increase wear resistance, can be embedded. A textured region 22 is formed in the protective layer 18 by means of an embossing element 20 (see FIG. 3), the textured element 24 which forms the textured region 22 being arranged in a substantially synchronous manner with the decorative element 26 which forms the decoration 16.

The dashed lines in FIG. 1 indicate the sawing lines 28 along which the base plate 10 is cut into individual panels 30 (into ten panels 30 in the present embodiment), it being possible to machine the panels 30, following cutting, along the peripheral edges thereof, in particular so as to form connection elements, for example connection elements of the tongue-and-groove type.

It can also be seen from FIG. 1 that half of the panels 30, namely the panels 30-1, are provided with a simulated longitudinal joint 32 (indicated by a dotted line), whereas the remainder of the panels 30, namely the panels 30-2, do not have a longitudinal joint of this type that extends in the longitudinal direction L of the panels. The simulated longitudinal joint 32 divides the decoration 16 of the panels 30-1 into a first decorative portion 16a and a second decorative portion 16b.

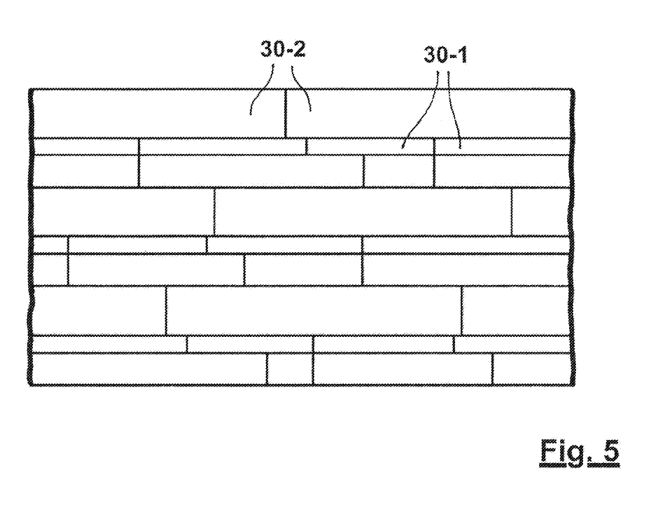

If the panels 30 produced from the base plate 10 are packaged and distributed together as panel units 34, a cover for a substrate, for example for a floor, a wall or a ceiling, can be formed from the panels 30, which cover has a three-plank appearance. In this case, the panel rows formed by the panels 30-2 form first planks which have a first width, whereas the panel rows formed by the panels 30-1 form second and third planks which have a width that is narrower than the first width. The widths of the second and third planks are preferably also different from one another. A substrate having an installation pattern of this kind is shown in FIG. 5 by way of example.

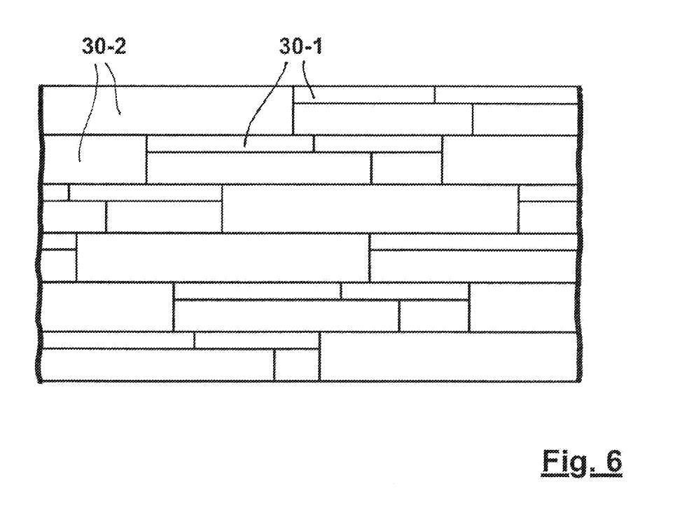

However, in principle, it is also possible to lay the panels 30 of the panel unit 34 according to the invention in a random manner, i.e. not following a specified order, which likewise produces an attractive appearance, as is the case with the substrate formed in this manner which is shown in FIG. 6.

According to the invention, the panels 30-1 are arranged on the base plate 10 so as to be directly adjacent to one another and symmetrical with respect to the central axis M of the width direction B of the base plate 10, with a deviation of at most one panel. As a result of this type of arrangement of the panels 30-1 on the base plate 10, in practice, paper growth, which cannot be completely avoided as a result of the decorative paper sheet 12 being impregnated with artificial resin, can affect the synchronicity, i.e. the congruence, of the decorative element 26 displaying the simulated longitudinal joint 32 and the textured element 24 displaying the simulated longitudinal joint 32, only to a small extent.

If it is assumed that the unavoidable misalignments are ±0.2%, therefore the maximum degree of offset between the decoration and the textured region between the left and the right edge of the base plate 10 having a width of 2050 mm is ±4.1 mm; yet the maximum degree of offset between the simulated longitudinal joints 32 of the leftmost panel 30-1 and the rightmost panel 30-1 is just ±1.64 mm. This value is halved again if the arrangement of the panels 30-1 is completely symmetrical with respect to the center M of the width extension B of the base plate 10 and if it is considered that paper growth from the center M of the width direction B is evenly distributed towards the two sides. However, misalignments of 0.82 mm can be tolerated by taking into account the fact that an actual joint which is formed by the chamfers which are provided on the edges of two adjoining machined panels 30 has a width of approximately 1.6 mm, and the simulated longitudinal joints 32 are therefore intended to have approximately the same width. The features according to the invention therefore ensure that the decorative element and the textured element 26, 24, which display the simulated longitudinal joint 32 overlap one another at least in part, in most cases completely, if the textured element 24 has a width b2 of approximately 1.5 mm to 1.6 mm and the decorative element 26 has a width b1 that is approximately 1 mm to 2 mm wider.

Of course, the joint width can also have other values. For example, the width of the joint can be between approximately 0.5 mm and approximately 6.0 mm, preferably between approximately 1.5 mm and 3.0 mm.

In this case, it should also be considered that the visual impression of the simulated longitudinal joint 32 when the panel 30-1 is viewed from above is dominated by the decorative element 26 displaying the simulated longitudinal joint 32, whereas, when the panel surface is glanced at, the visual impression is dominated by the textured element 24 displaying the simulated longitudinal joint 32 as a result of the degree of gloss of the panel surface. This effect can also be enhanced by the textured element 24 being formed having a different degree of gloss than the rest of the panel surface. The textured element 24 can preferably be designed to be very matte.

It should also be noted that the decorative element 26 displaying the simulated longitudinal joint 32 can gradually transition at the edges thereof into the surrounding decoration 16, i.e. without a sharply contrasted transition. This is indicated in FIG. 2 in a highly schematic manner by the height of the decorative element 16 which decreases towards the edges. Furthermore, the width of the decorative element 16 may have a certain amount of fluctuations in the longitudinal direction thereof. In the event that the decorative element and the textured element 26, 24, which display the simulated longitudinal joint 32, are intended to overlap one another only in part, these two features help make it possible to bring about this state in a manner which is not overly noticeable.

In order to increase the variability of the installation pattern which can be produced by the panel unit 34 according to the invention, at least some of the panels 30-1 can also comprise at least one simulated transverse joint 36 in addition to the simulated longitudinal joints 32. Even the panels 30-2 which do not comprise simulated longitudinal joints can be designed having transverse joints 36 of this type.

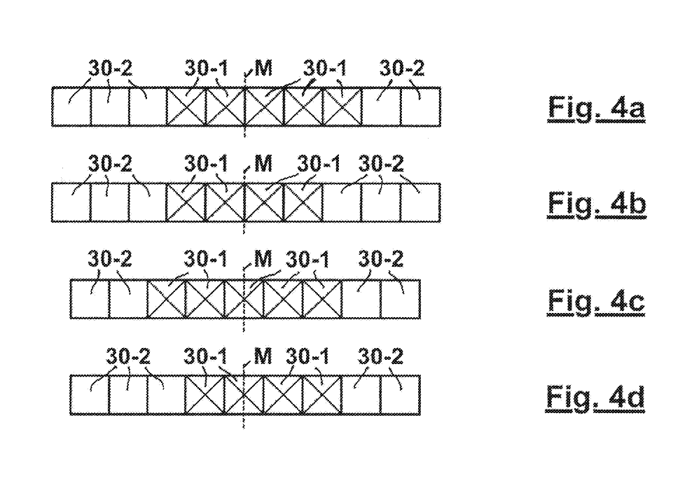

It should also be noted that it can be seen from FIGS. 4a to 4d what is meant by the wording “symmetrical with a deviation of at most one panel”:

If the base plate 10 comprises an even number of panels 30 in its width extension B and if an even number of panels 30-1 are provided with a simulated longitudinal joint 32 (FIG. 4b) or if the base plate 10 comprises an uneven number of panels 30 in its width extension B and if an uneven number of panels 30-1 are provided with a simulated longitudinal joint 32 (FIG. 4c), the panels 30-1 that are provided with a simulated longitudinal joint 32 are arranged symmetrically with respect to the center M of the width extension B of the base plate 10. If, however, the base plate 10 comprises an even number of panels 30 in its width extension B and if an uneven number of panels 30-1 are provided with a simulated longitudinal joint 32 (FIG. 4a) or if the base plate 10 comprises an uneven number of panels 30 in its width extension B and if an even number of panels 30-1 are provided with a simulated longitudinal joint 32 (FIG. 4d), more panels 30-1 that are provided with a simulated longitudinal joint 32 are arranged on one side of the center M of the width extension B of the base plate 10 than on the other side of the width center M.

It should also be noted that the embossing element 20 shown in FIG. 3 comprises a plurality of rectangular embossing regions 40, which are separated from one another in FIG. 3 by the dashed lines 42. In this case, it should be noted that there is no need for the embossing element 20 to comprise any of the embossing structures corresponding to the dashed lines 42, just as there is no need for the decoration 16 of the decorative paper sheet 12 to comprise any of the decorative elements corresponding to the dashed lines 28. In fact, the dashed lines 28 and 42 are merely used to make the invention easier to understand. However, in order to depict the simulated longitudinal joints 32, the embossing element 20 is designed having embossing structures 44 and, in order to depict the simulated transverse joints 36, the embossing element is designed having embossing structures 46. The embossing structures 44 divide the embossing regions 40 into first embossing portions 40a, which have a first width, and second embossing portions 40b, which have a second width.

In a similar manner, the decorative paper sheet 12 comprises a plurality of rectangular decorative regions 50, which are separated from one another in FIG. 1 by the dashed lines 28. In order to depict the simulated longitudinal joints 32, the decoration 16 of the decorative paper sheet 12 is designed having decorative elements 52 and, in order to depict the simulated transverse joints 36, the decoration is designed having decorative elements 54.

1. Panel unit comprising a plurality of rectangular panels intended for covering a substrate, wherein all of the panels have the same panel width, wherein each of the panels comprises a base element which comprises a decorative paper on the surface thereof which faces away from the substrate, which decorative paper is printed with a decoration on the visible surface thereof, which decoration has the appearance of a natural material, and wherein, using an embossing element, each panel is provided with a textured region which is substantially synchronous with the decoration on the visible surface of the decorative paper, and wherein the decoration of a first number of panels is divided into a first decorative portion having a first predetermined width and a second decorative portion having a second predetermined width by means of a simulated joint which extends in the longitudinal direction of the particular panel, whereas the decoration of the remainder of the panels is not divided up in the width direction in such a manner.

2. Panel unit according to claim 1, wherein the number of panels divided into the first decorative portion and the second decorative portion by means of the simulated joint is equal to the number of panels that are not divided up in such a manner.

3. Panel unit according to claim 1, wherein the width of the first decorative portion is different from the width of the second decorative portion.

4. Panel unit according to claim 1, wherein the ratio between the width of the decorative element which extends in parallel with the long sides of the rectangle and displays the simulated joint and the width of a portion of textured region which extends in parallel with the long sides of the rectangle and displays the simulated joint is between approximately 1.5 and approximately 3.0, preferably between approximately 1.7 and approximately 2.3.

5. Panel unit according to claim 1, wherein the portion of the textured region displaying the simulated joint has a degree of gloss that is different from the rest of the textured region.

6. Panel unit according to claim 1, wherein if the panels are provided with a chamfer at the outer edges thereof, the ratio between the width of the portion of the textured region displaying the simulated joint and the width of the chamfer is between approximately 1.8 and approximately 2.2, preferably approximately 2.0.

7. Panel unit according to claim 1, wherein the first decorative portion and/or the second decorative portion of at least one of the panels comprising a simulated longitudinal joint is/are divided into at least a first decorative sub-portion and a second decorative sub-portion by means of at least one simulated joint that extends in the width direction of the particular panel.

8. Embossing element for providing a textured region on a plate provided with a decoration, in particular for producing a panel unit according to claim 1, wherein the embossing element comprises a plurality of rectangular embossing regions which are arranged next to one another in the direction of the short sides of the rectangle, wherein a first number of embossing regions are divided into a first embossing portion having a first predetermined width and a second embossing portion having a second predetermined width by means of an embossing arrangement which extends in parallel with the long sides of the rectangle, whereas the remainder of the embossing regions do not have any embossing arrangements of this kind that extend in parallel with the long sides of the rectangle, and wherein the divided embossing regions are arranged on the embossing element so as to be directly adjacent to one another and symmetrical with respect to the width centre of the embossing element, with a deviation of at most one embossing region.

9. Embossing element according to claim 8, wherein the width of the first embossing portion is different from the width of the second embossing portion.

10. Embossing element according to claim 8, wherein the embossing arrangement displaying the simulated joint produces a degree of gloss during embossing which is different from the degree of gloss produced on the rest of the panel surface.

11. Embossing element according to claim 8, wherein the first embossing portion and/or the second embossing portion of at least one of the embossing regions is/are divided into at least a first embossing sub-portion and a second embossing sub-portion by means of at least one embossing arrangement which extends in parallel with the short sides of the rectangle.

12. Decorative paper which is printed with a decoration on the visible surface thereof, which decoration has the appearance of a natural material, wherein the decorative paper comprises a plurality of rectangular decorative regions which are arranged next to one another in the direction of the short sides of the rectangle, wherein a first number of decorative regions are divided into a first decorative portion having a first predetermined width and a second decorative portion having a second predetermined width by means of a decorative element which extends in parallel with the long sides of the rectangle, whereas the remainder of the decorative regions do not have any decorative elements of this kind that extend in parallel with the long sides of the rectangle, and wherein the divided decorative regions are arranged on the decorative paper so as to be directly adjacent to one another and symmetrical with respect to the width centre of the decorative paper, with a deviation of at most one decorative region.

13. Decorative paper according to claim 12, wherein the width of the first decorative portion is different from the width of the second decorative portion.

14. Decorative paper according to claim 12, wherein the first decorative portion and/or the second decorative portion of at least one of the decorative regions comprising a simulated longitudinal joint is/are divided into at least a first decorative sub-portion and a second decorative sub-portion by means of at least one simulated joint which extends in the width direction of the particular decorative region.
